(19) United States
(12) Patent Application Publication
(10) Pub. No.: US 2006/0172679 A1
(43) Pub. Date: Aug. 3, 2006

(54) Air duct outlets having slider controls for air directability

(76) Inventors: Thomas Franz Josef Gehring, Scarborough (CA); Ireneusz Jankowski, Richmond Hill (CA); Dejan Havidic, Toronto (CA)

Correspondence Address: MYERS BIGEL SIBLEY & SAJOVEC, PO BOX 37428, RALEIGH, NC, 27627, US

(21) Appl. No.: 11/234,029

(22) Filed: Sep. 23, 2005

Related U.S. Application Data
(60) Provisional application No. 60/612,988, filed on Sep. 24, 2004.

(51) Int. Cl. B60H 1/34

(52) U.S. Cl. 454/152

(57) ABSTRACT

An air duct outlet includes a housing comprising a bezel, an inlet, an outlet formed in the bezel, an air passageway extending from the inlet to the outlet, and an elongated slot formed in the bezel adjacent the outlet. A louver assembly is operably mounted within the housing and is configured to adjust the direction of air flowing through the air passageway. The louver assembly comprises a set of louvers pivotally secured in spaced-apart adjacent relationship. Each louver is pivotally secured about one of a plurality of substantially parallel axes, and the louvers are operably connected together such that pivotal movement of any one of the louvers causes pivotal movement of the remaining louvers. A slider member extends through the elongated slot in the bezel. The slider member is operably connected with the louvers and is configured to pivot the louvers in response to user movement thereof.

### RELATED APPLICATION

This application claims the benefit of and priority to U.S. Provisional Patent Application Ser. No. 60/612,988, filed Sep. 24, 2004, the disclosure of which is incorporated herein by reference as if set forth in its entirety.

### FIELD OF THE INVENTION

The present invention relates generally to vehicles and, more particularly, to air duct outlets utilized within vehicles.

### BACKGROUND OF THE INVENTION

Conventionally, vehicle interiors are provided with one or more air duct outlets which are connected by ducts to an outside air source and/or to a heating and/or air conditioning system that provides cooled and/or heated air. Because it is generally desirable for vehicle occupants to be able to adjust the direction of air flow within a vehicle interior, air duct outlets are typically provided with adjustable louvers. In addition, air duct outlets may be provided with dampers for allowing vehicle occupants to control the amount of air flowing therethrough.

Various types of air duct outlets can be provided depending upon special functions, air directability and design constraints within the vehicle. See, for example, U.S. Pat. Nos. 4,345,510; 4,702,156; and 4,006,673. Vehicle manufacturers are continuously seeking components, such as air duct outlets, that have enhanced functionality and durability, yet are cost effective to manufacture. Vehicle manufacturers are also continuously seeking components, such as air duct outlets, that can enhance styling within a vehicle, yet remain functional and economical.

### SUMMARY OF THE INVENTION

In view of the above discussion, an air duct outlet, according to some embodiments of the present invention, includes a housing comprising a bezel, an inlet, an outlet formed in the bezel, an air passageway extending from the inlet to the outlet, and an elongated slot formed in the bezel adjacent the outlet. A louver assembly is operably mounted within the housing and is configured to adjust the direction of air flowing through the air passageway. The louver assembly comprises a set of louvers pivotally secured in spaced-apart adjacent relationship. Each louver is pivotally secured about one of a plurality of substantially parallel axes, and the louvers are operably connected together such that pivotal movement of any one of the louvers causes pivotal movement of the remaining louvers. A slider member extends through the elongated slot in the bezel. The slider member is operably connected with the louvers and is configured to pivot the louvers in response to user movement thereof.

According to some embodiments of the present invention, an air duct outlet includes a housing comprising a bezel, an inlet, an outlet formed in the bezel, an air passageway extending from the inlet to the outlet, and first and second elongated slots formed in the bezel adjacent the outlet. A louver assembly is operably mounted within the housing and is configured to adjust the direction of air flowing through the air passageway. The louver assembly includes a first set of louvers pivotally secured in spaced-apart adjacent relationship, a second set of louvers pivotally secured in spaced-apart adjacent relationship, and respective first and second slider members configured to pivot the first and second sets of louvers in response to user movement thereof. Each louver in the first set is pivotally secured about one of a plurality of substantially parallel axes and are operably connected together such that pivotal movement of any one of the louvers in the first set causes pivotal movement of the remaining louvers in the first set. The first slider member extends through the first elongated slot and is operably connected with the first set of louvers and is configured to pivot the first set of louvers in response to user movement thereof;

Each louver in the second set is pivotally secured about one of a plurality of substantially parallel axes and are operably connected together such that pivotal movement of any one of the louvers in the second set causes pivotal movement of the remaining louvers in the second set. The second slider member extends through the second elongated slot and is operably connected with the second set of louvers and is configured to pivot the second set of louvers in response to user movement thereof.

The first set of louvers are operably connected together via a first connecting member that has an elongated configuration with a plurality of spaced-apart apertures formed therein. Each aperture is configured to operably engage a respective pin extending from an end portion of each louver in the first set. The second set of louvers are operably connected together via a second connecting member that has an elongated configuration with a plurality of spaced-apart apertures formed therein. Each aperture is configured to operably engage a respective pin extending from an end portion of each louver in the second set.

The first slider member is operably connected with the first set of louvers via a first linkage. The first linkage is pivotally connected to the housing and includes first and second slots formed in respective opposite end portions thereof. The first slot is operably associated with a pin that extends from the first connecting member and the second slot is operably associated with a pin that extends from the first slider member.

The second slider member is operably connected with the second set of louvers via a second linkage. The second linkage is pivotally connected to the housing and includes first and second slots formed in respective opposite end portions thereof. The first slot is operably associated with a pin that extends from the second connecting member, and the second slot is operably associated with a pin that extends from the second slider member.

### BRIEF DESCRIPTION OF THE DRAWINGS

The accompanying drawings, which form a part of the specification, illustrate key embodiments of the present invention. The drawings and description together serve to fully explain the invention.

FIG. 1 is a front, perspective view of an air duct outlet, according to embodiments of the present invention, mounted within an instrument panel of a vehicle.

FIG. 2 is an exploded view of the air duct outlet of FIG. 1.

FIG. 3 is a front, perspective view of the louver assembly in the air duct outlet of FIG. 1.

FIG. 4 is a bottom section view of the louver assembly of FIG. 3 taken along lines 4-4.

FIG. 5 illustrates movement of one of the slider controls of the louver assembly of FIG. 4.

FIG. 6 is a side section view of the louver assembly of FIG. 3 taken along lines 6-6.

FIG. 7 illustrates movement of the other one of the slider controls of the louver assembly of FIG. 6.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

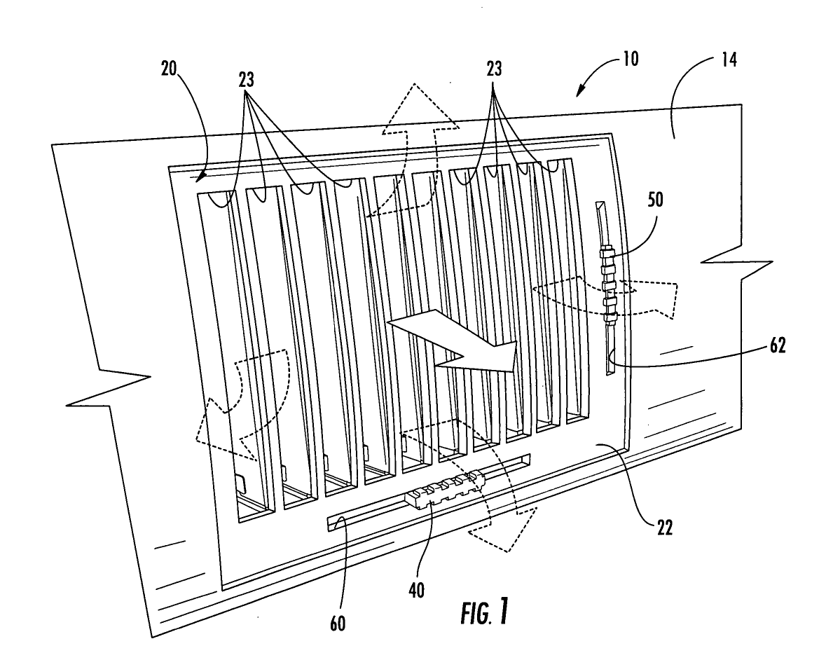

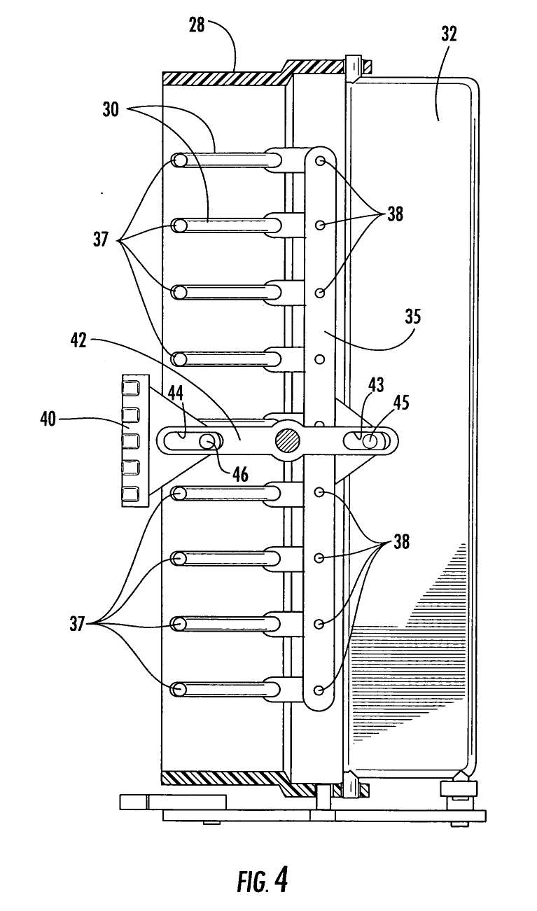

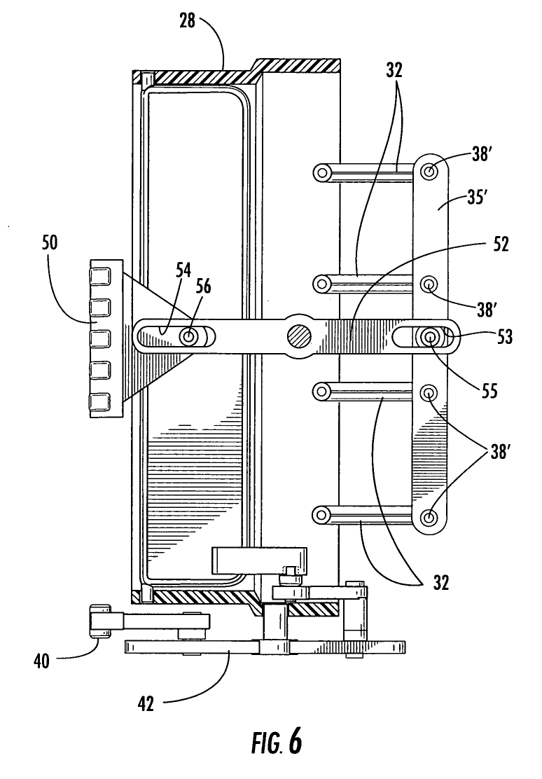

Referring to FIGS. 1-9, an air duct outlet 10, according to embodiments of the present invention, is illustrated. The illustrated air duct outlet 10 is designed for use within the interior compartments of vehicles, such as automobiles, trucks, trains, boats, aircraft, and the like. However, it is understood that air duct outlets according to embodiments of the present invention may be utilized in various environments (e.g., in homes and offices) and are not limited to use in vehicles.

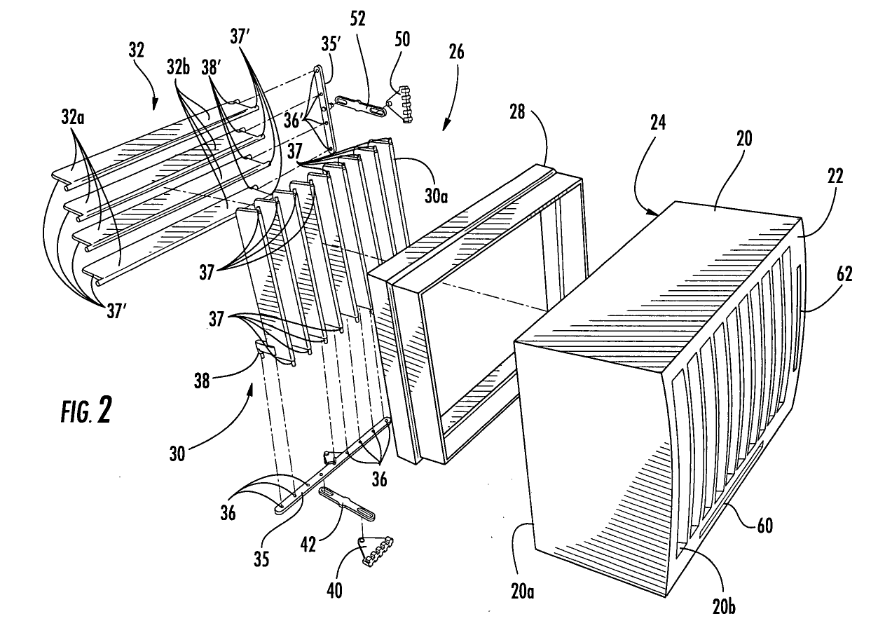

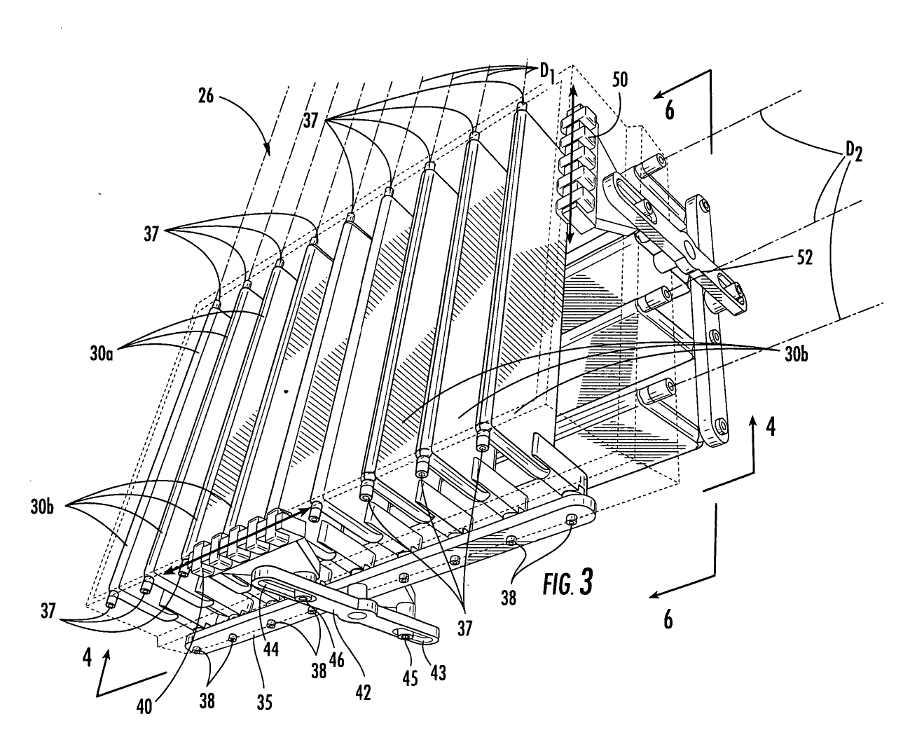

Referring initially to FIGS. 1-3, the illustrated air duct outlet 10 is disposed within an opening in the instrument panel 14 of a vehicle. The air duct outlet 10 includes a housing 20 having a front surface or bezel 22 within which a louver assembly 26 (FIGS. 2-3) is operably mounted. The louver assembly 26 is configured to adjust the direction of air flowing out of the air duct outlet 10. The illustrated louver assembly 26 includes a frame 28 and first and second sets of louvers 30, 32 pivotally secured to the frame 28. The louvers 30, 32 are configured to adjust the direction of air flowing through the housing 20 and out of the air duct outlet 10.

The housing bezel 22 includes a plurality of air outlet slots 23 through which air flows from an air source into a vehicle. The housing bezel 22 also includes a pair of elongated slots 60,62 positioned along the periphery of the bezel 22, as illustrated. Slider members 40,50 for controlling the direction of air flow extend outwardly through the elongated slots 60,62, respectively.

As would be understood by those skilled in the art, the air duct outlet 10 is configured to be connected to a source of air flow, such as a fan, that supplies heated and/or cooled air (as well as ambient outside air). Other embodiments of the present invention may include housings with different shapes and configurations (e.g., arcuate, round, elongated, etc.), and are not limited to the configuration of the illustrated housing 20.

In the illustrated embodiment, the first set of louvers 30 is secured to the frame 28 and positioned within the housing 20 adjacent the housing outlet 20b, and the second set of louvers 32 is secured to the frame 28 and positioned within the housing 20 adjacent the housing inlet 20a, as illustrated. The louvers 30 in the first set are in spaced-apart adjacent relationship, and each louver 30 is pivotally secured about one of a plurality of substantially parallel axes D₁. The first set of louvers 30 are operably connected together such that pivotal movement of any one of the louvers 30 causes pivotal movement of the remaining louvers 30 in the first set. The second set of louvers 32 are pivotally secured to the frame 28 and positioned within the housing 28 upstream from the first set of louvers 30, as illustrated. According to other embodiments of the present invention, the first set of louvers 30 may be positioned within the housing 28 upstream from the second set of louvers 30,

In the illustrated embodiment, the first and second sets of louvers 30, 32 do not overlap or engage with each other. The second set of louvers 32 are pivotally secured to the frame 28 within the housing 28 in spaced-apart adjacent relationship. Each louver 32 in the second set is pivotally secured about one of a second plurality of substantially parallel axes D₂ that are transverse to the pivot axes D₁ of the first set of louvers 30. The second set of louvers 32 are also operably connected together such that pivotal movement of any one of the louvers 32 causes pivotal movement of the remaining louvers 32 in the second set. In the illustrated embodiment, the first and second set of louvers 30, 32 are substantially orthogonal relative to each other. The pivot axes D₁,D₂ for the first and second sets of louvers 30, 32 may, but need not, lie in the same plane (i.e., coplanar).

The first set of louvers 30 are pivotally secured to the frame 28 via respective pins 37 that extend from opposite end portions 30a, 30b of each louver 30, as illustrated. Each pin 37 is configured to engage a respective aperture formed in the frame 28 and defines an axis D₁ about which each louver 30 pivots. The apertures are in spaced-apart, adjacent relationship to maintain the desired spacing of the louvers 30.

The louvers 30 are movably connected together along end portion 30b thereof via a connecting member 35. Pivotal movement of a single one of the louvers 30 causes pivotal movement of the remaining louvers 30. In the illustrated embodiment, the connecting member 35 has a slender, elongated configuration with a plurality of spaced-apart apertures 36 formed therein. Each aperture 36 is configured to operably engage a respective pin 38 extending from each louver end portion 30b.

The second set of louvers 32 are pivotally secured to the frame 28 via respective pins 37′ that extend from opposite end portions 32a, 32b of each louver 32, as illustrated. Each pin 37′ is configured to engage a respective aperture formed in the frame 28 and defines an axis D₂ about which each louver 32 pivots. The apertures are in spaced-apart, adjacent relationship to maintain the desired spacing of the louvers 32.

The louvers 32 are movably connected together along end portion 32b thereof via a connecting member 35′. Pivotal movement of a single one of the louvers 32 causes pivotal movement of the remaining louvers 32. In the illustrated embodiment, the connecting member 35′ has a slender, elongated configuration with a plurality of spaced-apart apertures 36′ formed therein. Each aperture 36′ is configured to operably engage a respective pin 38′ extending from each louver end portion 30b.

In the illustrated embodiment, a slider member 40 and linkage 42 are operably connected with the first set of louvers 30 and are configured to cause pivotal movement of the louvers 30. The linkage 42 is pivotally connected to the frame 28 and includes first and second slots 43,44. The first slot 43 is operably associated with a pin 45 that extends downwardly from the connecting member 35, as illustrated. The second slot 44 is operably associated with a pin 46 that extends downwardly from the slider member 40, as illustrated.

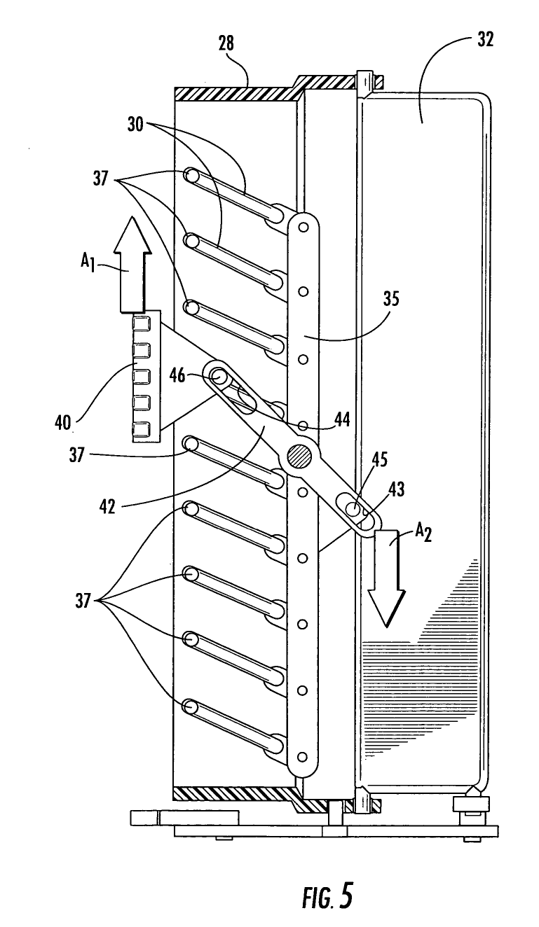

When a user moves the slider member 40 within bezel slot 60, the first set of louvers 30 are pivoted. For example, in FIG. 5, a user has moved slider member 40 in the direction indicated by arrow A₁ which has caused linkage 42 to pivot such that pin 45 engaged within slot 43 moves in the direction indicated by arrow A₂ which causes the louvers 30 to pivot as illustrated.

In the illustrated embodiment, a slider member 50 and linkage 52 are operably connected with the second set of louvers 32 and are configured to cause pivotal movement of the louvers 32. The linkage 52 is pivotally connected to frame 28 and includes first and second slots 53,54. The first slot 53 is operably associated with a pin 55 that extends downwardly from the connecting member 35′, as illustrated. The second slot 54 is operably associated with a pin 56 that extends downwardly from the slider member 50, as illustrated.

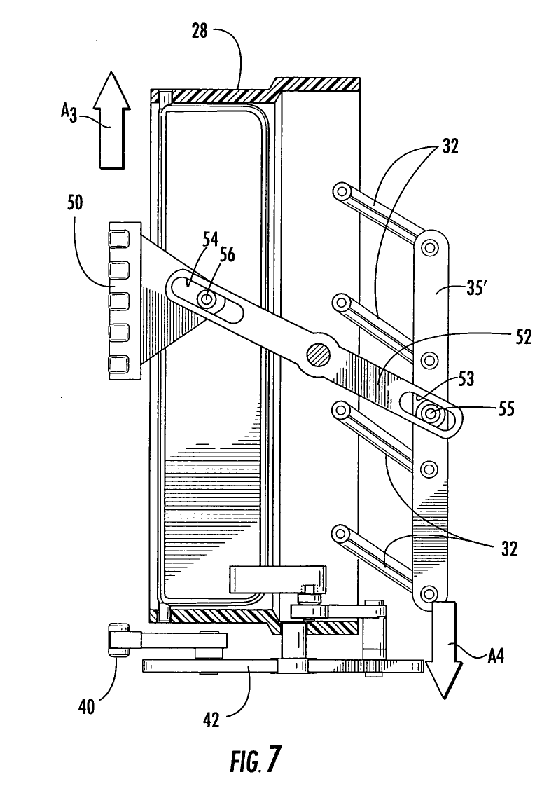

When a user moves the slider member 50 within bezel slot 62, the second set of louvers 32 are pivoted. For example, in FIG. 7, a user has moved slider member 50 in the direction indicated by arrow A₃ which has caused linkage 52 to pivot such that pin 55 engaged within slot 53 moves in the direction indicated by arrow A₄ which causes the louvers 32 to pivot as illustrated.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An air duct outlet, comprising:
a housing comprising a bezel, an inlet, an outlet formed in the bezel, an air passageway extending from the inlet to the outlet, and an elongated slot formed in the bezel adjacent the outlet; and
a louver assembly operably mounted within the housing, wherein the louver assembly is configured to adjust the direction of air flowing through the air passageway, wherein the louver assembly comprises:
a set of louvers pivotally secured in spaced-apart adjacent relationship, each louver pivotally secured about one of a plurality of substantially parallel axes, wherein the louvers are operably connected together such that pivotal movement of any one of the louvers causes pivotal movement of the remaining louvers; and
a slider member extending through the elongated slot, wherein the slider member is operably connected with the louvers and is configured to pivot the louvers in response to user movement thereof.

2. The air duct outlet of claim 1, wherein the louvers are operably connected together via a connecting member, wherein the connecting member has an elongated configuration with a plurality of spaced-apart apertures formed therein, and wherein each aperture is configured to operably engage a respective pin extending from each louver end portion.

3. The air duct outlet of claim 2, wherein the slider member is operably connected with the louvers via an elongated linkage, wherein the linkage is pivotally connected to the housing and includes first and second slots formed in respective first and second end portions thereof, wherein the first slot is operably associated with a pin that extends from the connecting member, and wherein the second slot is operably associated with a pin that extends from the slider member.

4. The air duct outlet of claim 1, wherein the louvers are substantially parallel with each other.

5. An air duct outlet, comprising:
a housing comprising a bezel, an inlet, an outlet formed in the bezel, an air passageway extending from the inlet to the outlet, and first and second elongated slots formed in the bezel adjacent the outlet; and
a louver assembly operably mounted within the housing, wherein the louver assembly is configured to adjust the direction of air flowing through the air passageway, wherein the louver assembly comprises:
a first set of louvers pivotally secured in spaced-apart adjacent relationship, each louver in the first set pivotally secured about one of a plurality of substantially parallel axes, wherein the louvers in the first set are operably connected together such that pivotal movement of any one of the louvers in the first set causes pivotal movement of the remaining louvers in the first set;
a first slider member extending through the first elongated slot, wherein the first slider member is operably connected with the first set of louvers and is configured to pivot the first set of louvers in response to user movement thereof;
a second set of louvers pivotally secured in spaced-apart adjacent relationship, each louver in the second set pivotally secured about one of a plurality of substantially parallel axes, wherein the louvers in the second set are operably connected together such that pivotal movement of any one of the louvers in the second set causes pivotal movement of the remaining louvers in the second set; and
a second slider member extending through the second elongated slot, wherein the second slider member is operably connected with the second set of louvers and is configured to pivot the second set of louvers in response to user movement thereof.

6. The air duct outlet of claim 5:
wherein the first set of louvers are operably connected together via a first connecting member, wherein the first connecting member has an elongated configuration with a plurality of spaced-apart apertures formed therein, and wherein each aperture is configured to operably engage a respective pin extending from an end portion of each louver in the first set; and
wherein the second set of louvers are operably connected together via a second connecting member, wherein the second connecting member has an elongated configuration with a plurality of spaced-apart apertures formed therein, and wherein each aperture is configured to operably engage a respective pin extending from an end portion of each louver in the second set.

7. The air duct outlet of claim 6, wherein the first slider member is operably connected with the first set of louvers via a first linkage, wherein the first linkage is pivotally connected to the housing and includes first and second slots formed in respective opposite end portions thereof, wherein the first slot is operably associated with a pin that extends from the first connecting member, and wherein the second slot is operably associated with a pin that extends from the first slider member.

8. The air duct outlet of claim 6, wherein the second slider member is operably connected with the second set of louvers via a second linkage, wherein the second linkage is pivotally connected to the housing and includes first and second slots formed in respective opposite end portions thereof, wherein the first slot is operably associated with a pin that extends from the second connecting member, and wherein the second slot is operably associated with a pin that extends from the second slider member.

9. The air duct outlet of claim 5, wherein the louvers in the first set of louvers are substantially parallel with each other.

10. The air duct outlet of claim 5, wherein the louvers in the second set of louvers are substantially parallel with each other.

11. The air duct outlet of claim 5, wherein the louvers in the first set of louvers are substantially orthogonal with the louvers in the second set of louvers.

12. The air duct outlet of claim 5, wherein the second set of louvers are positioned upstream from the first set of louvers within the housing.

13. An air duct outlet, comprising:
a housing comprising a bezel, an inlet, an outlet formed in the bezel, an air passageway extending from the inlet to the outlet, and first and second elongated slots formed in the bezel adjacent the outlet; and
a louver assembly operably mounted within the housing, wherein the louver assembly is configured to adjust the direction of air flowing through the air passageway, wherein the louver assembly comprises:
a first set of louvers pivotally secured in spaced-apart adjacent relationship, each louver in the first set pivotally secured about one of a plurality of substantially parallel axes, wherein the louvers in the first set are operably connected together via a first connecting member such that pivotal movement of any one of the louvers in the first set causes pivotal movement of the remaining louvers in the first set, wherein the first connecting member has an elongated configuration with a plurality of spaced-apart apertures formed therein, and wherein each aperture is configured to operably engage a respective pin extending from an end portion of each louver in the first set;
a first slider member extending through the first elongated slot, wherein the first slider member is operably connected with the first set of louvers via a first linkage and is configured to pivot the first set of louvers in response to user movement thereof, wherein the first linkage is pivotally connected to the housing and includes first and second slots formed in respective opposite end portions thereof, wherein the first slot is operably associated with a pin that extends from the first connecting member, and wherein the second slot is operably associated with a pin that extends from the first slider member;
a second set of louvers pivotally secured in spaced-apart adjacent relationship, each louver in the second set pivotally secured about one of a plurality of substantially parallel axes, wherein the louvers in the second set are operably connected together via a second connecting member such that pivotal movement of any one of the louvers in the second set causes pivotal movement of the remaining louvers in the second set, wherein the second connecting member has an elongated configuration with a plurality of spaced-apart apertures formed therein, and wherein each aperture is configured to operably engage a respective pin extending from an end portion of each louver in the second set; and
a second slider member extending through the second elongated slot, wherein the second slider member is operably connected with the second set of louvers via a second linkage and is configured to pivot the second set of louvers in response to user movement thereof, wherein the second linkage is pivotally connected to the housing and includes first and second slots formed in respective opposite end portions thereof, wherein the first slot is operably associated with a pin that extends from the second connecting member, and wherein the second slot is operably associated with a pin that extends from the second slider member.

14. The air duct outlet of claim 13, wherein the louvers in the first set of louvers are substantially parallel with each other.

15. The air duct outlet of claim 13, wherein the louvers in the second set of louvers are substantially parallel with each other.

16. The air duct outlet of claim 13, wherein the louvers in the first set of louvers are substantially orthogonal with the louvers in the second set of louvers.

17. The air duct outlet of claim 13, wherein the second set of louvers are positioned upstream from the first set of louvers within the housing.
